(19) United States
(12) Patent Application Publication
(10) Pub. No.: US 2026/0071085 A1
(43) Pub. Date: Mar. 12, 2026

(54) INK

(71) Applicant: KYOCERA DOCUMENT SOLUTIONS INC., OSAKA (JP)

(72) Inventors: KOTATSU KAWAGUCHI, OSAKA (JP); YUSUKE WASHINO, OSAKA (JP); KATSUKI OSANISHI, OSAKA (JP); HIROKA ITANI, OSAKA (JP); MOTOKI SUZUKI, OSAKA (JP); KENTARO OKINAKA, OSAKA (JP); SHUN KANDA, OSAKA (JP)

(21) Appl. No.: 19/322,609

(22) Filed: Sep. 8, 2025

(30) Foreign Application Priority Data
Sep. 9, 2024 (JP) 2024-155036

(51) Int. Cl. C09D 11/326; C09D 11/38

(52) U.S. Cl. CPC C09D 11/326; C09D 11/38

(57) ABSTRACT

An ink includes: a pigment, a pigment dispersion resin, 7 mass % or more and 20 mass % or less of polyethylene glycol having a molecular weight of 200 or more and 600 or less, 1 mass % or more and 15 mass % or less of 3-methyl-1,5-pentanediol, 1 mass % or more and 10 mass % or less of triethylene glycol monobutyl ether, and water.

### CROSS-REFERENCE TO RELATED PATENT APPLICATION

This application claims the benefit of Japanese Priority Patent Application JP 2024-155036 filed Sep. 9, 2024, the entire contents of which are incorporated herein by reference.

### FIELD OF THE DISCLOSURE

The present disclosure relates to an ink for forming an image by an inkjet method.

### BACKGROUND OF THE DISCLOSURE

An inkjet recording apparatus forms an image on a recording medium such as paper by repeatedly ejecting small droplets of ink from a nozzle onto the recording medium. In the recording medium such as paper formed of a fiber, a phenomenon (curling) in which the formation of an image by ink causes partial expansion and contraction of fibers, resulting in a warped shape, is likely to occur. Japanese Patent Application Laid-open No. 2004-209759 discloses a technology that blends polyethylene glycol in ink in order to prevent curling from occurring.

### SUMMARY OF THE DISCLOSURE

According to an embodiment of the present disclosure, there is provided an ink includes: a pigment; a pigment dispersion resin; 7 mass % or more and 20 mass % or less of polyethylene glycol having a molecular weight of 200 or more and 600 or less; 1 mass % or more and 15 mass % or less of 3-methyl-1,5-pentanediol; 1 mass % or more and 10 mass % or less of triethylene glycol monobutyl ether; and water.

### DETAILED DESCRIPTION OF THE EXEMPLARY EMBODIMENTS

In inks in which polyethylene glycol is blended, the viscosity increases, which leads to difficulty in ejection due to drying in the nozzle of a recording head, i.e., an intermittent ejection property is difficult to ensure. Further, in inks in which polyethylene glycol is blended, the density of the image formed on the recording medium tends to be reduced, and the ink tends to adhere to the paper output roller of the inkjet recording apparatus, causing a phenomenon (offset) in which the subsequent recording medium is stained via the paper output roller to easily occur.

In view of the circumstances as described above, it is an object of the present disclosure to provide an ink that is capable of suppressing the occurrence of curling and offset and ensuring an intermittent ejection property and image density.

An embodiment of the present disclosure will be described.

### [Configuration of Ink]

### (Schematic Configuration)

An ink according to an embodiment of the present disclosure includes: a pigment a; a pigment dispersion resin b; a water-soluble solvent c; and water. The ink according to this embodiment is typically a water-based ink that is ejected from a recording head of an inkjet recording apparatus onto a recording medium to form an image on the recording medium. The recording medium on which an image is to be formed by the ink according to this embodiment includes a fiber such as a cellulose fiber. Examples of such a recording medium include plain paper, copy paper, recycled paper, thin paper, and thick paper.

In the ink according to this embodiment, by blending three types of organic solvents as the water-soluble solvent c, it is possible to realize a configuration capable of suppressing the occurrence of curling and offset and ensuring an intermittent ejection property and image density. Further, the ink according to this embodiment favorably has dynamic surface tension at the surface age of 10 ms of 40.0 mN/m or less in order to ensure permeability into the recording medium and suppress offset. The ink according to this embodiment favorably has dynamic surface tension at the surface age of 10 ms of 25 mN/m or more in order to ensure image density. Details of each component of the ink according to this embodiment will be described below.

### (Pigment a)

In the ink according to this embodiment, for example, a yellow pigment, an orange pigment, a red pigment, a blue pigment, a purple pigment, or a black pigment can be used as the pigment a. Examples of the yellow pigment include C.I. Pigment Yellow 74, 93, 95, 109, 110, 120, 128, 138, 139, 151, 154, 155, 173, 180, 185, or 193. Examples of the orange pigment include C.I. Pigment Orange 34, 36, 43, 61, 63, or 71. Examples of the red pigment include C.I. Pigment Red 122 or 202. Examples of the blue pigment include C.I. Pigment Blue 15 or 15:3. Examples of the purple pigment include C.I. Pigment Violet 19, 23, or 33. Examples of the black pigment include C.I. Pigment Black 7.

The content of the pigment a in the ink according to this embodiment is favorably 4 mass % or more and 8 mass % or less. As a result, in the ink according to this embodiment, high image density in the image formed on the recording medium can be achieved more easily, and permeability into the recording medium can be ensured more easily. In the case where the content of the pigment a is less than 4 mass %, it becomes difficult to achieve high image density in the image formed on the recording medium. Meanwhile, in the case where the content of the pigment a exceeds 8 mass %, it becomes difficult to achieve permeability into the recording medium and fluidity of the pigment particle in the solvent cannot be ensured in some cases, thereby making it difficult to achieve high image density in the image formed on the recording medium.

### (Pigment Dispersion Resin b)

In the ink according to this embodiment, the pigment dispersion resin b for enhancing the dispersibility of the pigment a in the solvent is blended. The pigment dispersion resin b is fine particles of a resin and is adsorbed on the surface of the pigment a to suppress the agglomeration of the pigment a. In the ink in which the pigment dispersion resin b is blended, the pigment a and the pigment dispersion resin b integrally form a pigment particle (pigment dispersion). The pigment particle includes, for example, a core including the pigment a and the pigment dispersion resin b covering the core. Part of the pigment dispersion resin b may be dispersed in the solvent without being adsorbed on the surface of the pigment a.

As the pigment dispersion resin b, a known pigment dispersion resin can be selected as appropriate and used. Specific examples of the pigment dispersion resin b include a styrene-acrylic resin, a styrene-maleic acid copolymer, a styrene-maleic acid half ester copolymer, a vinylnaphthalene-acrylic acid copolymer, and a vinyl naphthalene-maleic acid copolymer. The styrene-acrylic resin is a resin including a unit derived from styrene and a unit derived from acrylic acid, methacrylic acid, acrylic acid ester, or methacrylic acid ester. Examples of the styrene-acrylic resin include a styrene-acrylic acid-acrylic acid alkyl ester copolymer, a styrene-methacrylic acid-methacrylic acid alkyl ester-acrylic acid alkyl ester copolymer, a styrene-acrylic acid copolymer, a styrene-maleic acid-acrylic acid alkyl ester copolymer, a styrene-methacrylic acid copolymer, and a styrene-methacrylic acid alkyl ester copolymer. Of these pigment dispersion resins b, a styrene-acrylic resin is favorable, a styrene-methacrylic acid-methacrylic acid alkyl ester-acrylic acid alkyl ester copolymer is more favorable, and a styrene-methacrylic acid-methyl methacrylate-butyl acrylate copolymer is particularly favorable because they can be easily prepared and have the excellent effect of dispersing the pigment a.

In the ink according to this embodiment, the content of the pigment dispersion resin b is favorably 0.4 mass % or more and 8 mass % or less. Further, it is favorable that in the ink according to this embodiment, 10 parts by mass or more and 100 parts by mass or less of the pigment dispersion resin b is blended with respect to 100 parts by mass of the pigment a.

### (Water-Soluble Solvent c)

In the ink according to this embodiment, polyethylene glycol, 3-methyl-1,5-pentanediol, and triethylene glycol monobutyl ether are blended as the water-soluble solvent c. In the ink according to this embodiment, the polyethylene glycol has a molecular weight of 200 or more and 600 or less. Further, in the ink according to this embodiment, the content of polyethylene glycol is 7 mass % or more and 20 mass % or less, the content of 3-methyl-1,5-pentanediol is 1 mass % or more and 15 mass % or less, and the content of triethylene glycol monobutyl ether is 1 mass % or more and 10 mass % or less.

In the ink according to this embodiment, by blending 7 mass % or more of polyethylene glycol having a molecular weight of 200 or more, it is possible to prevent curling from occurring. Further, in the ink according to this embodiment, by limiting the molecular weight of polyethylene glycol to 600 or less, it is possible to ensure an intermittent ejection property. Further, in the ink according to this embodiment, by limiting the content of triethylene glycol monobutyl ether to 10 mass % or less and blending 1 mass % or more of 3-methyl-1,5-pentanediol, it is possible to ensure image density. In addition, in the ink according to this embodiment, by limiting the content of polyethylene glycol to 20 mass % or less and blending 1 mass % or more of triethylene glycol monobutyl ether, it is possible to suppress the occurrence of offset. Further, in the ink according to this embodiment, by limiting the content of 3-methyl-1,5-pentanediol to 15 mass % or less and limiting the content of triethylene glycol monobutyl ether to 10 mass % or less, it is possible to enhance the redispersibility of the pigment particle in the solvent.

### (Surfactant d)

The ink according to this embodiment favorably includes a surfactant d. The surfactant d has the effect of enhancing the wettability of the ink on a recording medium and the effect of enhancing the compatibility and dispersion stability of each component included in the ink. Examples of the surfactant d included in the ink according to this embodiment include an anionic surfactant, a cationic surfactant, a non-ionic surfactant, and an amphoteric surfactant. As the surfactant blended in the ink according to this embodiment, a non-ionic surfactant is favorable. Of these, an acetylene glycol surfactant is particularly favorable.

### (Water)

In the ink according to this embodiment, ion exchanged water, purified water, distilled water, or the like can be used as water. In the ink according to this embodiment, the content of water is favorably 25.0 mass % or more and 80.0 mass % or less, more favorably 35.0 mass % or more and 60.0 mass % or less, from the viewpoints of dryness and ejection reliability.

### (Other Components)

In the ink according to this embodiment, components other than the above may be blended as necessary. For example, in the ink according to this embodiment, a surfactant different from the surfactant d may be blended as a dispersant for enhancing the dispersibility of the pigment a in the solvent. The surfactant blended as a dispersant reduces the interfacial tension between the pigment a and the solvent to enhance the dispersibility of the pigment a in the solvent. As such a surfactant, for example, a non-ionic surfactant or an anionic surfactant can be used.

Further, in the ink according to this embodiment, various additives such as a dissolution stabilizer, an anti-drying agent, an antioxidant, a viscosity adjustor, a pH adjuster, a neutralizer, an antifungal agent may be blended as necessary in addition to the above.

### EXAMPLES AND COMPARATIVE EXAMPLES

As Examples and Comparative Examples of the present disclosure, inks were prepared and evaluated.

### (Preparation of Ink)

First, a pigment dispersion liquid including the pigment a dispersed in water was prepared. The pigment dispersion resin b was diluted with ion exchanged water, the pigment a was added thereto, and then preliminary dispersion treatment was performed using a homodisper. After that, main dispersion treatment was performed using a bead mill (manufactured by NIPPON COKE & ENGINEERING. CO., LTD.) until the average particle size of the pigment particle reached 110 nm, thereby obtaining a pigment dispersion liquid. In all of the Examples and Comparative Examples, “Black Pearls 800” manufactured by CABOT was used as the pigment a. Further, in all of the Examples and Comparative Examples, “DISPERBYK-190” manufactured by BYK-Chemie GmbH was used as the pigment dispersion resin b. Note that the water included in the pigment dispersion liquid constitutes the water component in each ink.

Next, inks according to the Examples and Comparative Examples were prepared. The pigment dispersion liquid, the water-soluble solvent c, the surfactant d, and water were measured and placed in a beaker, and the content of the beaker was stirred at a rotational speed of 400 rpm using a stirrer (“Three-One Motor BL-600” manufactured by Shinto Scientific Co., Ltd.) and uniformly mixed, thereby obtaining an ink. The ink was filtered using a filter (pore size of 5 μm) to remove foreign substances and coarse particles included in the ink.

In the Examples and Comparative Examples, as the water-soluble solvent c, polyethylene glycol 400 (PEG400, average molecular weight: approximately 400, manufactured by Tokyo Chemical Industry Co., Ltd.), polyethylene glycol 1000 (PEG1000, average molecular weight: approximately 1000, manufactured by Tokyo Chemical Industry Co., Ltd.), diethylene glycol (DEG, molecular weight of: 106.12, manufactured by Tokyo Chemical Industry Co., Ltd.), 3-methyl-1,5-pentanediol (manufactured by Tokyo Chemical Industry Co., Ltd.), and triethylene glycol monobutyl ether (manufactured by Tokyo Chemical Industry Co., Ltd.) were used. Further, in all of the Examples and Comparative Examples, SURFYNOL 420 (manufactured by Nissin Chemical Co., Ltd.) that is an acetylene glycol surfactant was used as the surfactant d.

### Evaluation Method

The intermittent ejection property, the image density, the redispersibility, and difficulties of the occurrence of offset and curling of the inks according to the Examples and Comparative Examples were evaluated.

### Evaluation Device

For the evaluation of the intermittent ejection property, the image density, and the difficulties of the occurrence of offset and curling, a prototype evaluation device manufactured by KYOCERA Document Solutions Inc. was used as an inkjet recording apparatus and “KJ4B-QA” manufactured by KYOCERA Document Solutions Inc. was used as a recording head.

### Method of Evaluating Intermittent Ejection Property

The inside of the recording head was kept at 25° C. and the intermittent ejection property was evaluated in an environment of 10° C. and 15% RH. Specifically, for each ink, a first line image was formed on a recording medium by a recording head, and a second line image similar to the first line image was formed after passing through a non-image forming region where no image is formed. Then, whether or not the second line image is distorted was determined by microscopic observation. For each ink, a maximum value M (mm) of the dimension in the conveying direction of the non-image forming region where the second line image is not distorted was obtained, and the numerical value (=100×(M/420)) corresponding to the maximum value M when the dimension of A3 size in the longitudinal direction (420 mm) was 100 was used as an evaluation value for the intermittent ejection property. Using the evaluation value, evaluation was performed in accordance with the following criteria A and B. Inks with the evaluation for the intermittent ejection property of A are evaluated to “Pass”, and inks with the evaluation of B are evaluated to “Fail”.
A: 100 or more
B: less than 100.

### Method of Evaluating Image Density

The ejection amount of ink per ejection in each nozzle of the recording head was set to 11 pL, and a 10 cm×10 cm solid image was formed on a recording medium (“C2” manufactured by FUJIFILM Business Innovation Corp. (A4 size)). The recording medium on which the solid image was formed was held in a normal temperature and normal humidity environment for a day and a night. After that, for each solid image, the image density was measured at 10 places using a portable reflection densitometer RD-19 (manufactured by Gretag-Macbeth LLC), and the average value of the image densities at 10 places was used as an evaluation value for the image density. For each evaluation value, evaluation was performed in accordance with the following criteria A and B. Inks with the evaluation for the image density of A are evaluated to “Pass”, and inks with the evaluation of B are evaluated to “Fail”.
A: 1.1 or more
B: less than 1.1

### Redispersibility

A petri dish containing 2 g of each ink was set in a constant-temperature chamber and held at 40° C. for 72 hours. Ion exchanged water was added dropwise to each ink after holding at a rate of 5 ml/sec. When 10 seconds have elapsed since the adding dropwise, whether or not the pigment particle in each ink was dispersed in the solvent was visually observed. On the basis of the observation results, evaluation was performed in accordance with the following criteria A and B. Inks with the evaluation for the redispersibility of A are evaluated to “Pass”, and inks with the evaluation of B are evaluated to “Fail”.
A: the pigment particle is dispersed in water
B: the pigment particle is not dispersed in water

### Method of Evaluating Difficulty in Occurrence of Offset

First, the recording head located closest to the paper output roller in the evaluation device was filled with ink, and the excess liquid flowing onto the nozzle surface was wiped off using a wiping blade. In the evaluation device, the distance between the nozzle surface of the recording head and the recording medium was fixed to 1 mm, and the conveying speed of the recording medium from the paper feed roller to the paper output roller was set to 846.7 mm/sec. As the recording medium, “IJW” manufactured by Oji Paper Co., Ltd., which was cut to A4 size, was used. The amount of ink applied from the recording head to the recording medium was set to 15 g/m², and a 10 cm×10 cm solid image was continuously formed on 10 recording media using the evaluation device. For the 10th recording medium, the region (offset region) that is likely to be stained by the ink adhered to the paper output roller was read using an image scanner (“GT-X820” manufactured by Seiko Epson Corp.) and binarized at a threshold value of 220. An offset area ratio (%) (=100×the number of black pixels/the total number of pixels) was calculated from the number of black pixels and the total number of pixels of the binarized image, and the calculated offset area ratio was used as an evaluation value for the difficulty in the occurrence of offset. Using the evaluation value, evaluation was performed in accordance with the following criteria A and B as criteria for whether or not stain of a sheet of recording paper P due to the offset can be visually checked. Inks with the evaluation for the difficulty in the occurrence of offset of A are evaluated to “Pass”, and inks with the evaluation of B are evaluated to “Fail”.
A: 0.030% or less
B: exceeding 0.030%.

### Method of Evaluating Difficulty in Occurrence of Curling

The ejection amount of ink per ejection in each nozzle of the recording head was set to 11 pL, and a 10 cm×10 cm solid image was formed on a recording medium (“C2” manufactured by FUJIFILM Business Innovation Corp. (A4 size)). Immediately after that, the recording medium on which the solid image was formed was placed on the upper surface of a horizontal stand such that the solid image of the recording medium and the upper surface of the horizontal stand face each other. Then, the heights of the recording medium at the four corners from the upper surface of the horizontal stand were measured, and the average value of the heights of the recording medium at the four corners was used as an evaluation value for the difficulty in the occurrence of curling. Using the evaluation value, evaluation was performed in accordance with the following criteria A and B as criteria for whether or not the recording medium can be adsorbed for forming an image on the second side (back side) in double-sided printing when a suction fan of 0.8 KPa is used to perform suction and adsorption via a conveyor belt and straighten the recording medium using a decurling mechanism. Inks with the evaluation for the difficulty in the occurrence of curling of A are evaluated to “Pass”, and inks with the evaluation of B are evaluated to “Fail”.
A: 20 mm or less
B: exceeding 20 mm

### Examples 1 to 14

In Examples 1 to 14, inks were prepared by the above method such that the composition shown in Table 1 was achieved. Note that the units of the numerical values shown in Table 1 are “mass %”. In Examples 1 to 14, the amounts of the pigment dispersion resin b, polyethylene glycol, 3-methyl-1,5-pentanediol, triethylene glycol monobutyl ether, and the surfactant d were varied.

TABLE 1

| | | Component | | | | | | |
|---|---|---|---|---|---|---|---|---|
| | | Pigment | Resin | Water-soluble solvent | | | Surfactant | |
| | | a | b | PEG 400 | MPD | BTG | d | Water |
| Example | 1 | 5 | 2 | 10 | 15 | 7 | 0.5 | Remainder |
| | 2 | 5 | 2 | 15 | 10 | 7 | 0.5 | Remainder |
| | 3 | 5 | 2 | 20 | 5 | 7 | 0.5 | Remainder |
| | 4 | 5 | 2 | 10 | 15 | 2 | 0.5 | Remainder |
| | 5 | 5 | 2 | 15 | 10 | 2 | 0.5 | Remainder |
| | 6 | 5 | 2 | 20 | 5 | 2 | 0.5 | Remainder |
| | 7 | 5 | 2 | 20 | 15 | 10 | 0.5 | Remainder |
| | 8 | 5 | 2 | 7 | 1 | 1 | 0.5 | Remainder |
| | 9 | 5 | 2 | 20 | 15 | 1 | 0.5 | Remainder |
| | 10 | 5 | 2 | 7 | 1 | 10 | 0.5 | Remainder |
| | 11 | 5 | 4 | 15 | 10 | 7 | 0.5 | Remainder |
| | 12 | 5 | 2 | 15 | 10 | 7 | 0.6 | Remainder |
| | 13 | 5 | 2 | 15 | 10 | 7 | 0.8 | Remainder |
| | 14 | 5 | 2 | 15 | 10 | 7 | 1.0 | Remainder |

For the inks according to Examples 1 to 14, the intermittent ejection property, the image density, the redispersibility, and the difficulties of the occurrence of offset and curling were evaluated. Table 2 shows the evaluation results of the intermittent ejection property, the image density, the redispersibility, and the difficulties of the occurrence of offset and curling for the inks according to Examples 1 to 14. In all of the inks according to Examples 1 to 14, the intermittent ejection property, the image density, the redispersibility, and the difficulties of the occurrence of offset and curling were evaluated to “Pass”.

TABLE 2

| | | Evaluation result | | | | | | | | |
|---|---|---|---|---|---|---|---|---|---|---|
| | | Intermittent | | | | | | | | |
| | | ejection property | | Image density | | | Offset | | Curling | |
| | | Evaluation | | Evaluation | | Redispersibility | Evaluation | | Evaluation | |
| | | value | Evaluation | value | Evaluation | Evaluation | value (%) | Evaluation | value (mm) | Evaluation |
| Example | 1 | 120 | A | 1.16 | A | A | 0.020 | A | 16 | A |
| | 2 | 120 | A | 1.14 | A | A | 0.022 | A | 12 | A |
| | 3 | 125 | A | 1.14 | A | A | 0.025 | A | 9 | A |
| | 4 | 115 | A | 1.17 | A | A | 0.022 | A | 17 | A |
| | 5 | 115 | A | 1.15 | A | A | 0.025 | A | 13 | A |
| | 6 | 115 | A | 1.14 | A | A | 0.028 | A | 9 | A |
| | 7 | 135 | A | 1.21 | A | A | 0.019 | A | 8 | A |
| | 8 | 100 | A | 1.12 | A | A | 0.029 | A | 20 | A |
| | 9 | 125 | A | 1.19 | A | A | 0.025 | A | 9 | A |
| | 10 | 105 | A | 1.10 | A | A | 0.025 | A | 20 | A |
| | 11 | 115 | A | 1.13 | A | A | 0.021 | A | 13 | A |
| | 12 | 120 | A | 1.14 | A | A | 0.021 | A | 12 | A |
| | 13 | 120 | A | 1.13 | A | A | 0.019 | A | 12 | A |
| | 14 | 115 | A | 1.12 | A | A | 0.017 | A | 12 | A |

Further, in the inks according to Examples 2 and 12 to 14, the content of the surfactant d differs, i.e., the surface tension differs. Table 3 shows the dynamic surface tension at the surface age of 10 ms of the inks according to Examples 2 and 12 to 14. The dynamic surface tension at the surface age of 10 ms of each ink was measured using a bubble pressure dynamic surface tensiometer (“BP-100” manufactured by KRUSS GmbH). On the basis of the evaluation results of the ink according to Examples 2 and 12 to 14, it was confirmed that favorable results could be achieved for all of the intermittent ejection property, the image density, the redispersibility, and the difficulties of the occurrence of offset and curling in the configuration with dynamic surface tension at a surface age of 10 ms of 40.0 mN/m or less.

TABLE 3

| | | Dynamic surface tension (mN/m) |
|---|---|---|
| Example | 2 | 40 |
| | 12 | 35 |
| | 13 | 30 |
| | 14 | 25 |

### Comparative Examples 1 to 8

In Comparative Examples 1 to 8, inks were prepared by the above method such that the composition shown in Table 4 was achieved. Note that the units of the numerical values shown in Table 4 are “mass %”. In Comparative Examples 1 to 8, the configuration of the water-soluble solvent c was different from those in the above Examples. Specifically, the ink according to Comparative Example 1 is different from the inks according to the above Examples in that 3-methyl-1,5-pentanediol is not included. The ink according to Comparative Example 2 is different from the inks according to the above Examples in that the content of 3-methyl-1,5-pentanediol exceeds 15 mass %. The ink according to Comparative Example 3 is different from the inks according to the above Examples in that the content of polyethylene glycol is less than 8 mass %. The ink according to Comparative Example 4 is different from the inks according to the above Examples in that the content of polyethylene glycol exceeds 20 mass %. The ink according to Comparative Example 5 is different from the inks according to the above Examples in that triethylene glycol monobutyl ether is not included. The ink according to Comparative Example 6 is different from the inks according to the above Examples in that the content of triethylene glycol monobutyl ether exceeds 10 mass %. The ink according to Comparative Example 7 is different from the inks according to the above Examples in that polyethylene glycol 400 is not used but polyethylene glycol 1000 is used instead thereof. The ink according to Comparative Example 8 is different from the inks according to the above Examples in that polyethylene glycol 400 is not used butdiethylene glycol is used instead thereof.

TABLE 4

| | | Component | | | | | | | | |
|---|---|---|---|---|---|---|---|---|---|---|
| | | | | Water-soluble solvent | | | | | | |
| | | Pigment | Resin | PEG | PEG | | | | Surfactant | |
| | | a | b | 400 | 1000 | DEG | MPD | BTG | d | Water |
| Comparative | 1 | 5 | 2 | 20 | | | | 10 | 0.5 | Remainder |
| Example | 2 | 5 | 2 | 7 | | | 20 | 1 | 0.5 | Remainder |
| | 3 | 5 | 2 | 5 | | | 15 | 10 | 0.5 | Remainder |
| | 4 | 5 | 2 | 25 | | | 1 | 1 | 0.5 | Remainder |
| | 5 | 5 | 2 | 20 | | | 1 | | 0.5 | Remainder |
| | 6 | 5 | 2 | 7 | | | 1 | 15 | 0.5 | Remainder |
| | 7 | 5 | 2 | | 15 | | 10 | 7 | 0.5 | Remainder |
| | 8 | 5 | 2 | | | 15 | 10 | 7 | 0.5 | Remainder |

For the inks according to Comparative Examples 1 to 8, the intermittent ejection property, the image density, the redispersibility, and the difficulties of the occurrence of offset and curling were evaluated. Table 5 shows the evaluation results of the intermittent ejection property, the image density, the redispersibility, and the difficulties of the occurrence of offset and curling for the inks according to Comparative Examples 1 to 8.

TABLE 5

| | | Evaluation result | | | | | | | | |
|---|---|---|---|---|---|---|---|---|---|---|
| | | Intermittent | | | | | | | | |
| | | ejection property | | Image density | | | Offset | | Curling | |
| | | Evaluation | | Evaluation | | Redispersibility | Evaluation | | Evaluation | |
| | | value | Evaluation | value | Evaluation | Evaluation | value (%) | Evaluation | value (mm) | Evaluation |
| Comparative | 1 | 115 | A | 1.09 | B | A | 0.025 | A | 9 | A |
| Example | 2 | 115 | A | 1.21 | A | B | 0.024 | A | 16 | A |
| | 3 | 115 | A | 1.18 | A | B | 0.020 | A | 21 | B |
| | 4 | 115 | A | 1.11 | A | A | 0.033 | B | 7 | A |
| | 5 | 120 | A | 1.13 | A | A | 0.031 | B | 9 | A |
| | 6 | 115 | A | 1.08 | B | B | 0.015 | A | 19 | A |
| | 7 | 90 | B | 1.17 | A | A | 0.024 | A | 13 | A |
| | 8 | 120 | A | 1.19 | A | A | 0.021 | A | 22 | B |

The ink according to Comparative Example 1 was evaluated to “Fail” for the image density. This is presumably because in the ink according to Comparative Example 1 in which 3-methyl-1,5-pentanediol is not included, the agglomeration of the pigment particle was insufficient. Further, the ink according to Comparative Example 2 was evaluated to “Fail” for the redispersibility. This is presumably because in the ink according to Comparative Example 2 in which the content of 3-methyl-1,5-pentanediol is large, the agglomeration of the pigment particle was excessive.

The ink according to Comparative Example 3 was evaluated to “Fail” for the redispersibility and the difficulty in the occurrence of curling. This is presumably because in the ink according to Comparative Example 3 in which the content of polyethylene glycol is small, the agglomeration of the pigment particle was excessive and the permeability into the recording medium increased. Further, the ink according to Comparative Example 4 was evaluated to “Fail” for the difficulty in the occurrence of offset. This is presumably because in the ink according to Comparative Example 4 in which the content of polyethylene glycol is large, the ink was caused to easily adhere to the paper output roller due to the increase in viscosity.

The ink according to Comparative Example 5 was evaluated to “Fail” for the difficulty in the occurrence of offset. This is presumably because in the ink according to Comparative Example 5 in which triethylene glycol monobutyl ether is not included, the increase in viscosity due to polyethylene glycol could not be suppressed, causing the ink to easily adhere to the paper output roller. Further, the ink according to Comparative Example 6 was evaluated to “Fail” for the image density and the redispersibility. This is presumably because in the ink according to Comparative Example 6 in which the content of triethylene glycol monobutyl ether is large, the viscosity was insufficient.

The ink according to Comparative Example 7 was evaluated to “Fail” for the intermittent ejection property. This is presumably because in the ink according to Comparative Example 7 in which polyethylene glycol has a large molecular weight, the ink was caused to easily adhere to the paper output roller due to the increase in viscosity. Further, the ink according to Comparative Example 8 was evaluated to “Fail” for the difficulty in the occurrence of curling. This is presumably because in the ink according to Comparative Example 8 in which diethylene glycol having a molecular weight smaller than that of polyethylene glycol is included, the permeability into the recording medium increased.

What is claimed is:

1. An ink, comprising:
a pigment;
a pigment dispersion resin;
7 mass % or more and 20 mass % or less of polyethylene glycol having a molecular weight of 200 or more and 600 or less;
1 mass % or more and 15 mass % or less of 3-methyl-1,5-pentanediol;
1 mass % or more and 10 mass % or less of triethylene glycol monobutyl ether; and
water.

2. The ink according to claim 1, which has dynamic surface tension at a surface age of 10 ms of 40.0 mN/m or less.

3. The ink according to claim 1, wherein
a content of the pigment dispersion resin is 4 mass % or less.

4. The ink according to claim 1, further comprising
an acetylene glycol surfactant.
